(19) United States
(12) Patent Application Publication
(10) Pub. No.: US 2026/0328926 A1
(43) Pub. Date: Oct. 22, 2026

(54) AIR/SPACE OBJECT DECONFLICTION TOOL FOR LASER DIRECTED ENERGY WEAPONS

(71) Applicant: Raytheon Systems Limited, Harlow (GB)

(72) Inventors: Robert Ian Young, Wellend (GB); Bentley Hames, Hitchin (GB); Mark Stephen Whitbread, Luton (GB)

(21) Appl. No.: 19/694,728

(22) Filed: Jun. 1, 2026

Related U.S. Application Data
(63) Continuation of application No. PCT/GB2024/052920, filed on Nov. 19, 2024.

(30) Foreign Application Priority Data
Dec. 1, 2023 (GB) 2318437.7

(51) Int. Cl. G01S 13/72; F41H 13/00; G01S 13/58

(52) U.S. Cl. CPC G01S 13/726; F41H 13/0062; G01S 13/58

(57) ABSTRACT

Apparatus and methods for providing situational awareness for laser directed energy weapon (LDEW) operators are disclosed. One such apparatus includes a processor and a memory, which obtain tracking data for each of a plurality of air objects, orbital trajectory forecast data for each of a plurality of space objects, and data identifying a targeted sky region. The processor identifies a subset of objects that are forecasted to intersect the targeted sky region during a given time range from the pluralities of air objects and space objects, based on their respective tracking data or orbital trajectory forecast data. The apparatus then transmits or stores a dataset comprising data for each object in the subset. This information can be used to generate firing recommendations for the targeted sky region, enhancing crew safety and preventing unintentional collateral damage.

### CROSS-REFERENCE TO RELATED APPLICATION AND PRIORITY CLAIM

This application claims priority as a continuation of International Patent Application No. PCT/GB2024/052920 filed on Nov. 19, 2024, which claims priority to United Kingdom Patent Application No. 2318437.7 filed on Dec. 1, 2023. Both of these applications are hereby incorporated by reference in their entirety.

### TECHNICAL FIELD

The invention relates to tools and associated methods for deconfliction involving space objects and air objects. The tools and methods are suitable for deconfliction when using a variety of weapon systems, and in particular, laser directed energy weapon (LDEW) systems.

### BACKGROUND

Recent developments in laser technology have led to a novel class of arms known as Laser Directed Energy Weapons (LDEW). These weapons are very useful to armed forces for several reasons. LDEW do not require traditional kinetic ammunition, instead firing a beam of light generated from a supply of electricity. This means that they do not need to be frequently reloaded in the way that other kinds of weapons do, they have a low per-shot-fired operating cost, and they avoid the logistical difficulties associated with the need to carry a supply of ammunition around. Moreover, they can be fired very accurately and precisely, minimizing collateral damage.

However, there are valid concerns that the laser beam may unintentionally strike a third-party object causing it damage. This limits the capacity for safe firing of the LDEW because of the risk of inadvertently irradiating non-hostile objects. Indeed, many of the same factors that make LDEW highly advantageous when used against enemy forces also present highly disadvantageous “fratricide” risks—if there is any confusion or misidentification of a target, there is very little time to correct the mistake before the laser radiation takes effect on its target. There is very little possibility of missing the friendly target in the case of accidental fratricide, and often very little that the friendly target can do to protect itself. Use of LDEW against airborne or space targets is particularly prone to these risks, since other (non-hostile) entities may be passing by within a small angle from the target, in the same general “patch of sky”. As used herein, air objects may include, but are not limited to, airplanes, helicopters, drones, unmanned aerial vehicles (UAVs), missiles, balloons, and the like. As used herein, space objects may include objects orbiting the Earth, such as satellites (e.g., artificial satellites), space stations, and the like.

In typical deployment of LDEW, deconfliction is not managed by the operator(s) of the weapon in the field, but is instead managed off-board by a local commander back at HQ. This kind of remote management adds a severe amount of latency to the decision-making process.

It is known that the United States Air Force (USAF) operates a service (a ‘space clearing house’) to provide US armed forces with information about which region(s) of the sky an LDEW can be fired into safely, based on locations of satellites. However, the USAF service is limited to a satellite deconfliction role, and as such it does not consider other pertinent entities such as aircraft, space objects, or the like.

Some known LDEW systems have a GUI designed to manage the operation of the weapon. This GUI is designed to allow a single operator to control the system, including provision of targeting information. However, these systems lack on-board aircraft deconfliction capabilities. Instead, aircraft deconfliction must be managed off-board, e.g., via the local headquarters.

It would be desirable to improve upon these known systems and methods.

### SUMMARY

According to a first aspect of the disclosure, an apparatus is provided that comprises a processor and a memory, with the memory containing instructions that, when executed by the processor, cause the processor to obtain tracking data for each of a plurality of air objects, orbital trajectory forecast data for each of a plurality of space objects, and data identifying a targeted sky region; identify a subset of objects that are forecasted to intersect the targeted sky region during a given time range from the pluralities of air objects and space objects, based on their respective tracking data or orbital trajectory forecast data; and transmit or store a dataset comprising data for each object in the subset.

This first aspect of the disclosure results in the production and transmission/storage of a dataset useable for performing effective and efficient deconfliction. The steps carried out by the processor enable the output dataset (which can be fed to a deconfliction tool or LDEW) to be considerably more lightweight and immediately useful than would otherwise be required for deconfliction purposes. Because the dataset produced only needs to contain information pertaining to just those objects that are relevant for the targeted sky region and given time range, deconfliction can be carried out without the deconfliction tool or LDEW having to process data for every single object in the sky. Moreover, by pre-calculating the dataset for the relevant objects in this way (i.e., before initiating the actual deconfliction process itself), fewer steps need to be performed by the deconfliction tool or LDEW, and fewer computational resources are required by the deconfliction tool or LDEW. In this way, the bulk of the difficult processing can be carried out by apparatus according to the first aspect located e.g., at headquarters (HQ), at joint force command (JFC), or at a mobile operating base (MOB), freeing up time, processing power and other resources for tools and weapon systems in the active field of combat (where time and resources may be more limited and more critical).

According to a second aspect of the disclosure, an apparatus is provided that comprises a processor, a memory and a display device, the memory comprising instructions which, when executed by the processor, cause the processor to receive a transmitted or stored dataset comprising data for each object, of a plurality of air objects and a plurality of space objects, that is forecasted to intersect a targeted sky region during a given time range; generate a firing recommendation for the targeted sky region for a specified time based on the received dataset; and present the firing recommendation to a user via the display device.

This second aspect of the disclosure acts as an air/space deconfliction tool that uses a lightweight but powerful dataset to assist LDEW operators in making informed decisions about when and where to fire the weapon, reducing the risk of unintended consequences or collateral damage.

According to a third aspect of the disclosure, a method is provided that comprises obtaining tracking data for each of a plurality of air objects, orbital trajectory forecast data for each of a plurality of space objects, and data identifying a targeted sky region; identifying a subset of objects that are forecasted to intersect the targeted sky region during a given time range from the pluralities of air objects and space objects, based on their respective orbital trajectory forecast data; and transmitting or storing a dataset comprising data for each object in the subset.

According to a fourth aspect of the disclosure, a method is provided that comprises receiving a transmitted or stored dataset comprising data for each object, from a plurality of air objects and a plurality of space objects, that is calculated to intersect a targeted sky region during a given time range, generating a firing recommendation for the targeted sky region for a specified time, based on the received dataset, and presenting the firing recommendation to a user via a display device.

Optionally, in some examples, the orbital trajectory forecast data may be obtained by a step of calculating it for each space object, based on orbital element data received for each of a plurality of space objects.

Optionally in some examples, the orbital trajectory forecast data (however it is obtained, i.e., calculated, received, or otherwise) may be or may comprise an ephemeris for each space object. Optionally in some examples, the orbital trajectory forecast data (however obtained) may be or may comprise a position table for each space object. Optionally in some examples, the orbital trajectory forecast data (however obtained) may be or may comprise a position/velocity table for each space object. Optionally in some examples, the orbital trajectory forecast data (however obtained) may comprise position data defined relative to the Earth (or a point thereon/therein), for example position data expressed in terms of right ascension and declination (or any other suitable 2D astronomical coordinates), or as 3D position data in any suitable coordinate system. Optionally in some examples, the orbital trajectory forecast data (however obtained) comprises position data (and optionally other data e.g., velocity data) for each space object over the course of a predetermined time period, e.g., over a coming 24 hour period.

The dataset may be stored on any suitable memory device, e.g., a hard disk drive (HDD), solid state drive (SSD), flash memory device, USB drive, memory card, or the like. The dataset may be transmitted and/or received via any suitable one or more wired or wireless hardware and/or software components facilitating the exchange of data and acting as an intermediary to transmit, receive, and interpret said data in a consistent and standardized manner, such as an ethernet, Wi-Fi, serial communication, cellular communication, TCP/IP, and the like. Advantageously, transmission of the dataset allows it to be used immediately (or substantially immediately) for air/space deconfliction once it has been generated without any delay being incurred. Advantageously, storing the dataset allows it to be transferred to a deconfliction tool or LDEW without any need for transmission, which may provide security benefits, and which may be necessary in some cases where the nature of an active combat zone renders the transmission of signals impossible, unsafe, or otherwise inappropriate.

As used herein, “specified time” may refer to either a moment/point in time, or a window/range of time, unless otherwise dictated by context. References to occupation of a sky region “at the specified time” may therefore refer to the presence of an object in the region when the moment/point occurs in the former case, or may refer to the presence of an object in the region at any moment/point within the window/range in the latter case.

Optionally, in some examples, the data identifying the targeted sky region may be received from the LDEW system itself (e.g., from sensors and/or software installed in the LDEW system), and/or from a deconfliction tool. The deconfliction tool may be located in, on or near the LDEW, or may be configured for use in, on or near the LDEW. The deconfliction tool may be part of or coupled to the LDEW. Optionally, in some examples, the data identifying a targeted sky region may comprise data identifying an LDEW position and/or data identifying an LDEW angular configuration.

Optionally in some examples, the firing recommendation may be generated by determining whether any object (air or space) is forecasted to occupy the targeted sky region at the specified time. This provides the advantage of a simple and straightforward method for generating firing recommendations based on the presence or absence of air/space objects in the targeted sky region.

In the simplest case, a negative firing recommendation is generated upon determining that any air or space object will occupy the targeted sky region at the specified time (i.e., at a specified moment or during a specified window), and a positive firing recommendation is generated otherwise (that is, upon determining that none of the objects will occupy the targeted sky region at the specified moment, or at any moment during the specified window, as the case may be).

In certain further cases, the criteria for generating a negative firing recommendation may be stricter, and/or the criteria for generating a positive firing recommendation may be more relaxed. For example, a positive firing recommendation may be generated even when an air or space object is determined to occupy the targeted sky region, based on a hostility status of the object indicating that the object pertains to hostile or non-allied forces. In some examples, generating the firing recommendation comprises generating a warning upon determining that an object of neutral or unknown hostility status will occupy the targeted sky region at the specified time. A hostility status may comprise an indication that an air or space object is one of the following: allied, hostile, neutral, unknown.

Optionally in some examples, the transmitted or stored dataset may comprise a comma separated variables (CSV) table, one or more JSON objects, and/or a database such as a relational database.

Optionally in some examples, the orbital element data may comprise a plurality of two-line element (TLE) sets, which can provide a standardized and widely-used format for representing the orbital elements of space objects. TLE data can be obtained, for example, from the website http://www.space-track.org (or rather an API thereof), which is provided by the United States Air Force and which allows TLE data to be queried up to once per hour for standard users. As explained by Wikipedia's entry for “Two-line element set”, a TLE is “a data format encoding a list of orbital elements of an Earth-orbiting object for a given point in time, the epoch. Using a suitable prediction formula, the state (position and velocity) at any point in the past or future can be estimated to some accuracy . . . A TLE set may include a title line preceding the element data, so each listing may take up three lines in the file. The title is not required, as each data line includes a unique object identifier code”. The specific fields and formats for TLE data can be found both at https://www.space-track.org/documentation#tle and also at https://en.wikipedia.org/wiki/Two-line_element_set. Further information may be found in CROITORU, Emilian-Ionuţ & Oancea, Gheorghe. (2016). SATELLITE TRACKING USING NORAD TWO-LINE ELEMENT SET FORMAT. SCIENTIFIC RESEARCH AND EDUCATION IN THE AIR FORCE. 18. 423-432. 10.19062/2247-3173.2016.18.1.58.

Optionally in some examples, the orbital element data may be derived from various sources, such as space object catalogues, space domain awareness sources, space situational awareness sources, space surveillance/tracking sources, and/or cameras or sensors, which can be either ground-based or space-based. This provides the advantage of obtaining comprehensive and up-to-date information about space objects from a reliable source. The use of multiple sources can advantageously further improve the accuracy and reliability of the orbital trajectory forecast data. The SDA/SSA/SST sources may themselves be space objects.

The integration of air object tracking data in the present invention provides the advantage of enabling a deconfliction tool to account for a greater number of relevant object classes (i.e., both space objects and air objects) when performing deconfliction and generating firing recommendations, which further enhances situational awareness for LDEW operators.

According to various implementations of the presently disclosed technology, the orbital trajectory forecast data and the air object tracking data can be integrated/fused/combined in a variety of different possible ways. In some examples, data for space objects (e.g., orbital trajectory forecast data) and data for air objects (e.g., tracking data) may be handled entirely separately from one another up to the point of having produced a first dataset comprising data for each space object in the subset of the plurality of space objects and a second dataset comprising data for each air object in the subset of the plurality of air objects, and then combining said first and second dataset as a final step. In other examples, space object data and air object data (e.g., orbital trajectory forecast data and air object tracking data) can be combined at an earlier step in the process to obtain a fusion dataset, which is then used to identify a subset of relevant objects (air or space) based on the targeted sky region and given time range. Such a fusion dataset may comprise position and/or timing data for all of the air and space objects in a common coordinate system or frame of reference. Position data may comprise 3D position data relative to Earth or 2D position data relative to the view from the LDEW. In one example, the fusion dataset may comprise ephemerides for each air object and each space object, and may be processed to determine a subset of the plurality of (overall) objects that are forecasted to intersect the targeted sky region during a given time range based on their respective data (e.g., position and/or timing data) in the fusion dataset. In effect, filtering and then combining the two sets of data can be substituted for combining and then filtering the two sets of data, and vice versa.

The given time range for the subset of the plurality of air objects may be the same as the given time range for the subset of the plurality of space objects. Alternatively, the given time ranges for the plurality of air objects and the plurality of space objects may differ. In some examples, the given time range for the plurality of air objects overlaps with the given time range for the plurality of space objects.

An object (either air or space) can be deemed to be “forecasted” to intersect the targeted sky region if tracking data or orbital trajectory forecast data received/calculated at a particular time indicates that the object's position currently expected, assumed, thought, held, deemed, or predicted to fall within the targeted sky region at that same time. In other words, if “fresh” or “live” data indicates that an object is contemporaneously present within the targeted sky region, then said object can be held to have been forecasted to intersect the targeted sky region at that time, and should not be excluded from being considered as such merely for the reason that the forecasting in this case relates to a predicted “current” position rather than a predicted future position of the object.

In one contemplated example, there is provided an apparatus for deconflicting a plurality of objects comprising a plurality of space objects and a plurality of air objects, the apparatus comprising a processor and a memory, the memory comprising instructions which, when executed by the processor, cause the processor to: receive orbital element data for a plurality of space objects; receive tracking data for a plurality of air objects; receive data identifying a targeted sky region; calculate, based on the received orbital element data, orbital trajectory forecast data for each space object; calculate a fusion dataset for the plurality of objects based on the calculated orbital trajectory forecast data and the tracking data; identify a subset of the plurality of objects that are forecasted to intersect the targeted sky region during a given time range based on their respective data in the fusion dataset; and transmitting or storing either i) a dataset (different to the fusion dataset) comprising data for each object in the subset of the plurality of objects, or ii) safety indication data for the targeted sky region during the given time range based on the identified subset. The safety indication data may be as simple as a single binary or Boolean value indicating whether it is safe to fire at the targeted sky region during the given time range, but could comprise additional data (e.g., indications of whether it is safe to fire at a plurality of sub-ranges within the given time range, indications of whether it is safe to fire in a plurality of sub-regions of the targeted sky region, etc.). There is also contemplated a first corresponding apparatus comprising a processor, a memory and a display device, the memory comprising instructions which, when executed by the processor, cause the processor to: receive a transmitted or stored dataset comprising data for each object, of a plurality of objects, that is forecasted to intersect a targeted sky region during a given time range; generate a firing recommendation for the targeted sky region for a specified time, based on the received dataset; and present the firing recommendation to a user via the display device. There is also contemplated a second corresponding apparatus comprising a processor, a memory and a display device, the memory comprising instructions which, when executed by the processor, cause the processor to: receive safety indication data for a targeted sky region and given time range based on an identified subset of a plurality of objects that are forecasted to intersect the targeted sky region during the given time range based on their respective data in a fusion dataset; generate a firing recommendation for the targeted sky region for a specified time, based on the received safety indication data; and present the firing recommendation to a user via the display device.

In examples where a first subset of targeted-region-intersecting air objects and a second subset of targeted-region-intersecting space objects are computed independently before being combined, in order to ensure that the LDEW/deconfliction tool is not overloaded either with excessive computational burden or excessive data to process, it is preferred that the steps of identifying the subset of the plurality of space objects and identifying the subset of the plurality of air objects are both performed on the same apparatus and/or at the same site, e.g., at the HQ, JFC or MOB. Nevertheless, examples are contemplated in which the processor of a first apparatus obtains (either by receipt, or by calculation from received orbital element data) the orbital trajectory forecast data, obtains the data identifying a targeted sky region, identifies the subset of the space objects forecasted to intersect the targeted sky region, and transmits/stores a dataset comprising data for each space object in the subset; and then the processor of a second apparatus (distinct from the first apparatus) obtains the tracking data for the air objects, identifies the subset of the air objects forecasted to intersect the targeted sky region, and either a) transmits/stores a dataset comprising data for each air object in the air object subset, b) adds or includes data for each air object in the air object subset into the transmitted/stored dataset comprising data for each space object in the space object subset, or c) generates (and presents) a firing recommendation for the targeted sky region based on the transmitted/stored space object dataset together with the identified subset of air objects.

Optionally in some examples, the tracking data may comprise various types of data, such as local air picture data, air traffic management data, allied force air object tracking data, wide-area sensor feed data, or targeting data from a sensor of an LDEW system. This provides the advantage of obtaining comprehensive and up-to-date information about air objects from a reliable source. Multiple sources can be used, to improve the accuracy and reliability of the tracking data.

Optionally in some examples, the apparatus or method may present the firing recommendation to the user in various ways, such as through a graphical user interface, a velocity azimuth display visualization, a 2D plan view, a cone representing the targeted region (optionally color-coded based on the firing recommendation), representations of positions and/or trajectories for one or more air objects, or representations of positions and/or trajectories for one or more space objects. This provides the advantage of offering a customizable and user-friendly way for LDEW operators to visualize and understand the firing recommendations and optionally also the air/space objects informing said recommendations.

Optionally in some examples, the apparatus or method may compute a firing recommendation for each of a plurality of sub-regions of the targeted sky region and present a graphical user interface depicting the firing recommendation computed for each sub-region. This provides the advantage of providing more detailed and granular information within the firing recommendation, which can help LDEW operators make more precise decisions about when and where to fire the weapon. For example, an LDEW operator may still be enabled to fire the weapon safely at a hostile target within the targeted sky region even in the case that a non-hostile air or space object also occupies the overall targeted sky region, if the hostile target and non-hostile object occupy different sub-regions.

To this end, the received dataset (and hence also the transmitted or stored dataset) can optionally comprise positional data and timing data for each space object or air object calculated to intersect the targeted sky region during the given time range. For example, this positional data and timing data may comprise entry/exit times or entry/exit locations (or a combination thereof) for air/space objects as described below. The positional data may comprise 3D positional data (e.g., coordinates relative to Earth) and/or 2D positional data (e.g., coordinates for the targeted sky region as viewed by the LDEW). In any case, computing the firing recommendation for each sub-region may comprise performing linear interpolation using the positional and/or timing data, or may comprise applying a curve-fitting algorithm to the positional and/or timing data. Linear interpolation has been found to be a highly computationally efficient way to compute sub-region recommendations whilst still retaining a high degree of accuracy and assurance for the resulting recommendations. Curve-fitting algorithms have been found to provide extremely high accuracy/high-fidelity approximations for the positions of air objects or space objects in the targeted sky region, thus allowing the size/angular extent of the sub-regions to be reduced without compromising safety, enabling higher-resolution firing recommendations to be provided.

Optionally in some examples, the transmitted or stored dataset may comprise entry and/or exit timing data for each space object in the subset of the plurality of space objects and each air object in the subset of the plurality of air objects, for each of a plurality of sub-regions of the targeted sky region. This provides the advantage of offering more detailed information about the timing of space objects and air objects entering and exiting the sub-regions, which can further enhance situational awareness for LDEW operators.

The targeted sky region may be of any suitable shape and size. In some exemplary cases, the targeted sky region may define a square cross-section with an angular extent of from 5 degrees to 10 degrees, from 10 degrees to 15 degrees, from 15 degrees to 20 degrees, from 20 degrees to 30 degrees, from 30 degrees to 45 degrees, from 45 degrees to 60 degrees, from 60 degrees to 75 degrees, from 75 degrees to 90 degrees, from 90 degrees to 120 degrees, from 120 degrees to 150 degrees, or from 150 degrees to 180 degrees.

The targeted sky region may comprise a cone, field, zone, sector, patch, frustum, volume, or area of the sky. It may be defined as particular angular extent. It may comprise elevation and azimuth information. Optionally, it may also comprise a spatial extent towards the sky—that is, the targeted sky region may only extend as far as a certain distance from the observer in a particular direction, such as 100 m, 1000 m, 5000 m, 10000 m, and so on—though this is not necessary (i.e., the targeted sky region may extend infinitely far out into space). Where the targeted sky region comprises a spatial extent toward the sky, this may be defined in terms of height, e.g., height above sea level, particularly when the targeted sky region is defined by reference to the vertical (direction perpendicular to the surface of Earth).

The targeted sky region may be defined by reference to a focal point in the sky (also known as a point of view), e.g., a particular window or angular extension around the focal point. The targeted sky region may be defined by astronomical azimuth and elevation values.

The targeted sky region may be notionally divided into any suitable number of sub-regions in any suitable arrangement. In some exemplary cases, the number of sub-regions may be 2, 3, 4, 5, 6, 7, 8, 9, 16, 25, 36, 49, 64, 81 or 100. The sub-regions may be overlapping or non-overlapping. The sub-regions may optionally form a partition of the targeted sky region.

The sub-regions may be of any suitable shape and size. In some exemplary cases, each sub-region may define a square cross-section with an angular extent of from 1 degree to 2 degrees, from 2 degrees to 3 degrees, from 3 degrees to 4 degrees, from 4 degrees [symbol] degrees, from 5 degrees to 10 degrees, from 10 degrees to 15 degrees, from 15 degrees to 20 degrees, from 20 degrees to 30 degrees, from 30 degrees to 45 degrees, from 45 degrees to 60 degrees, from 60 degrees to 75 degrees, or from 75 degrees to 90 degrees. It is not essential for all of the sub-regions to be of an identical shape or size.

In one exemplary case, the targeted sky region has an angular extent of 30 degrees by 30 degrees and the plurality of sub-regions comprises nine sub-regions each with an angular extent of 10 degrees by 10 degrees. Other acceptable arrangements will be readily apparent to those of ordinary skill in the art.

Optionally in some examples, a laser directed energy weapon system may be provided that comprises the apparatus or is configured to perform the method described above. This provides the advantage of integrating the situational awareness features directly into the LDEW system, which can improve the overall safety and effectiveness of the weapon system.

Optionally in some examples, the laser directed energy weapon system may be configured to provide a warning to an operator of the weapon system and/or prevent the weapon system from being fired in accordance with the firing recommendation being a negative firing recommendation. This provides the advantage of enhancing safety and preventing unintentional collateral damage by automatically warning the operator or preventing the firing of the LDEW when unsafe conditions or risks are identified.

According to a fifth aspect of the disclosure, a method is provided that comprises obtaining tracking data for each of a plurality of air objects, orbital trajectory forecast data for a plurality of space objects, and data identifying a targeted sky region; identifying a subset of objects that are forecasted to intersect the targeted sky region during a given time range from the pluralities of air objects and space objects, based on their respective tracking data or orbital trajectory forecast data; generating a firing recommendation for the targeted sky region for a specified time, based on the identified subset; and presenting the firing recommendation to a user via a display device.

According to a sixth aspect of the disclosure, a non-transitory computer-readable medium is provided that comprises instructions which, when executed by a computer, cause the computer to perform any method described above.

Aspects of the present invention improve upon the USAF space clearing house service by considering a different technical question—rather than, “where can the LDEW be fired”, the present invention has been designed to address the question “when can the LDEW be fired, given that a particular region of sky is targeted?”.

### BRIEF DESCRIPTION OF THE DRAWINGS

Exemplary embodiments will now be described with reference to the appended Figures, in which:

FIGS. 1a and 1b illustrate an exemplary use of a laser directed energy weapon (LDEW);

FIGS. 1c and 1d illustrate an example of sub-optimal use of an LDEW in a scenario where an adequate deconfliction capability has not been provided;

FIG. 2a is a diagrammatic representation of an embodiment of the present invention;

FIG. 2b is a diagrammatic representation of another embodiment of the invention;

FIG. 3a graphically depicts tracking data and calculated orbital trajectory forecasts for each of a plurality of air and space objects and a sky region targeted by an LDEW;

FIG. 3b graphically depicts the same tracking data and forecasts for the same objects from the perspective of the LDEW and shows the targeted sky region subdivided into a plurality of sub-regions;

FIG. 4a illustrates a first example of using air object and space object data to identify a subset of a plurality of objects forecasted to intersect a targeted sky region;

FIG. 4b illustrates a second example of using air object and space object data to identify a subset of a plurality of objects forecasted to intersect a targeted sky region;

FIG. 5a illustrates an example of orbital trajectory forecast data for a space object calculated based on orbital element data received for a plurality of space objects;

FIG. 5b illustrates an example of orbital trajectory forecast data in an alternative format, relative to a position of an LDEW;

FIG. 5c illustrates an example of data identifying a targeted sky region alongside orbital trajectory forecast data;

FIG. 5d illustrates various examples of formats for a dataset comprising data for each object in a subset of a plurality of objects that are forecasted to intersect a targeted sky region during a given time range;

FIG. 6 illustrates various examples of graphical user interface features suitable for presenting a firing recommendation to a user;

FIG. 7 is a component diagram of one exemplary embodiment of the present invention; and

FIG. 8 is a flow diagram depicting steps of various aspects of the present invention.

### DETAILED DESCRIPTION

The detailed description set forth below provides information and examples of the disclosed technology with sufficient detail to enable those skilled in the art to practice the disclosure.

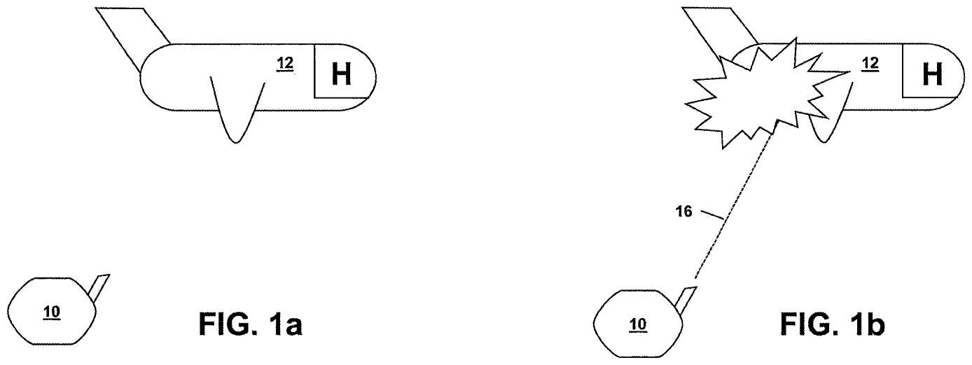

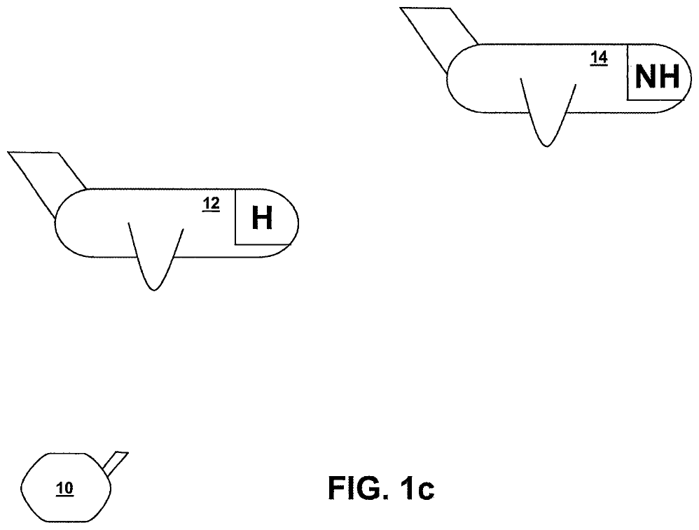

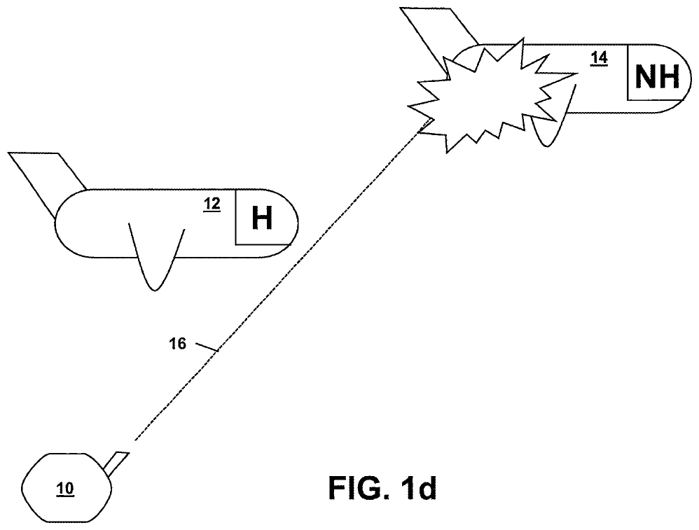

FIGS. 1a and 1b show an exemplary use of a laser directed energy weapon (LDEW). FIG. 1a illustrates a scenario where an LDEW system 10 is used to engage a hostile target 12 (designated “H”), such as a drone, or an unmanned aerial vehicle (UAV). As shown in FIG. 1b, the LDEW system 10 is configured to emit a laser beam 16 that is directed towards the target 12. FIG. 1b shows the LDEW system 10 successfully engaging the target 12, causing it to be destroyed or disabled.

FIGS. 1c and 1d illustrate an example of sub-optimal use of an LDEW in a scenario where an adequate deconfliction capability has not been provided. As can be seen from FIG. 1c, the hostile target 12 may occupy the same region of sky (from the perspective of LDEW system 10) as a non-hostile object 14 (designated “NH”), which may be an allied or neutral target, and which may be an airplane, helicopter, UAV, satellite, or any other object in air or space. In FIG. 1d, the LDEW system 10 is again used with the aim of engaging hostile target 12. However, in this scenario, non-hostile object 14 is present in the line of fire of laser beam 16. FIG. 1d shows the unintended consequence of the LDEW system 10 engaging the target 12, as non-hostile object 14 is also damaged or destroyed due to the lack of suitable deconfliction capability.

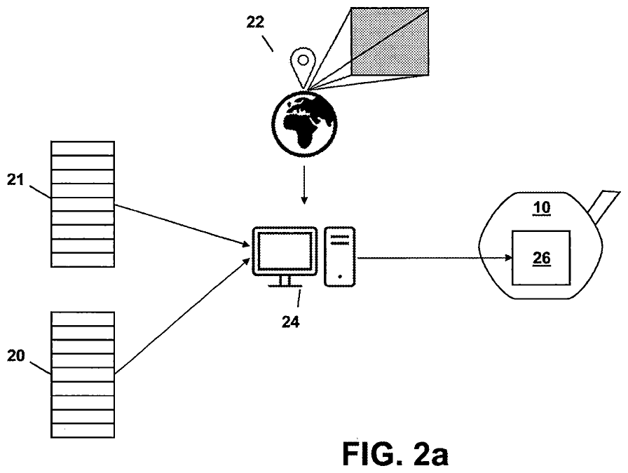

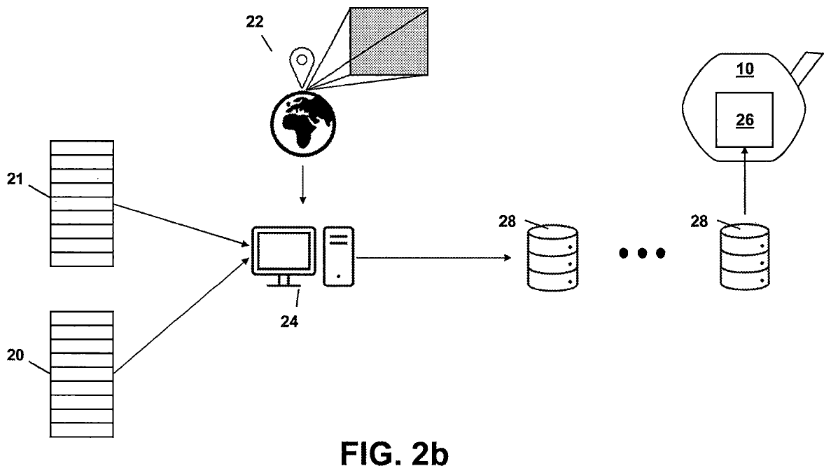

FIG. 2a is a diagrammatic representation of an embodiment of the present disclosure, showing a first apparatus 24, a second apparatus 26 (e.g., a deconfliction tool), and an LDEW system 10. First apparatus 24 comprises a processor and a memory, the memory comprising instructions which, when executed by the processor, cause the processor to: obtain tracking data 21 for each of a plurality of air objects, orbital trajectory forecast data 20 for each of a plurality of space objects, and data 22 identifying a targeted sky region; identify a subset of objects that are forecasted to intersect the targeted sky region during a given time range from the pluralities of air objects and space objects, based on their respective tracking data or orbital trajectory forecast data; and transmit a dataset comprising data for each object in the subset. Second apparatus 26 comprises a processor, memory and display device, the memory comprising instructions which, when executed by the processor, cause the processor to: receive the transmitted dataset, generate a firing recommendation for the targeted sky region for a specified time, based on the received dataset; and present the firing recommendation to a user via the display device. In the illustrated example, second apparatus 26 is part of (or installed in) LDEW system 10, though in various practical cases the two may be standalone devices.

FIG. 2b shows an embodiment which is substantially similar to that shown in FIG. 2a (with like reference numerals denoting like features), with the distinction that in this case, the dataset is stored on a memory device 28 by apparatus 24, and subsequently received from memory device 28 by apparatus 26. This may be accomplished e.g., by memory device 28 being physically picked up and moved from one site or system to another. The stored dataset may be received either immediately after calculation or at some later time, e.g., at a time closer to a desired time for firing the LDEW. Advantageously, by using a database/dataset, no “live” position or trajectory data is required for deconfliction by apparatus 26, nor any connection to apparatus 24; the data is instead precomputed and held in memory.

Long-term storage of the dataset (of data for each object calculated to intersect the targeted sky region during the given time range) by the deconfliction tool (apparatus 26) or LDEW system 10 is highly advantageous, because it allows the firing recommendation to be generated at a firing time further down the line, even if fresh or up-to-date data for the air and/or space objects is no longer accessible to the weapon operator(s) (e.g., if internet connection is lost). This is the case whether said dataset is immediately stored to memory device 28 (as in FIG. 2b) or transmitted to (and subsequently stored by) the tool/apparatus/LDEW as in FIG. 2a.

The data 22 identifying the targeted sky region may be manually input, may be automatically received from the LDEW itself, and/or may be automatically generated based on the current mission parameters or threat assessment. Data 22 may define the LDEW configuration, i.e., the totality of its x/y/z/pitch/yaw/roll configuration relative to Earth.

Orbital trajectory forecast data 20 may be calculated from orbital element data (not shown) for each of the plurality of space objects. The orbital element data may be derived from one or more optical camera or sensor devices, and/or from one or more radar devices. The orbital element data may be updated (e.g., by a provider, and/or by using SDA/SSA sensor data) with a specific frequency, for example once every 12 hours or once every 24 hours. The air object tracking data may be updated with a specific frequency, for example once every second, once every 5 seconds, once every 10 seconds, once every 30 seconds, once every minute, once every 5 minutes, once every 10 minutes, once every 30 minutes, once every hour, once every 3 hours, once every 6 hours, once every 12 hours or once every 24 hours. The specific frequency with which the air object tracking data is updated may fall in a range between any pair of the values listed above.

The method executed by the processor of first aspect of the invention (e.g., first apparatus 24) may be run at any suitable frequency, for example once every 12 hours or once every 24 hours. Equivalently, the method of the third aspect of the invention may be run at any suitable frequency, for example once every 12 hours or once every 24 hours. Even a 24-hour frequency for running the method and creating/updating the dataset used for deconfliction has been found to provide a very high degree of deconfliction accuracy, due to the fact that orbital element data itself typically changes by only a comparatively small amount on a daily basis, with space objects in a defined orbit around the Earth typically tending to follow the same orbit in the absence of any unforeseen external forces. Higher-frequency execution of the method (e.g., every 12, 6, 3, 2, or 1 hour(s) or every 30, 15, 10, 5, 3, 2 or 1 minute(s)) may improve deconfliction accuracy by ensuring that the dataset used for deconfliction is based on more up-to-date information. Lower-frequency execution of the method (e.g., every 12, 24, 36 or 48 hours) has the advantage of a reduced usage of computational resources (bandwidth, memory, processing power, access to APIs) which may be more critical in a combat situation.

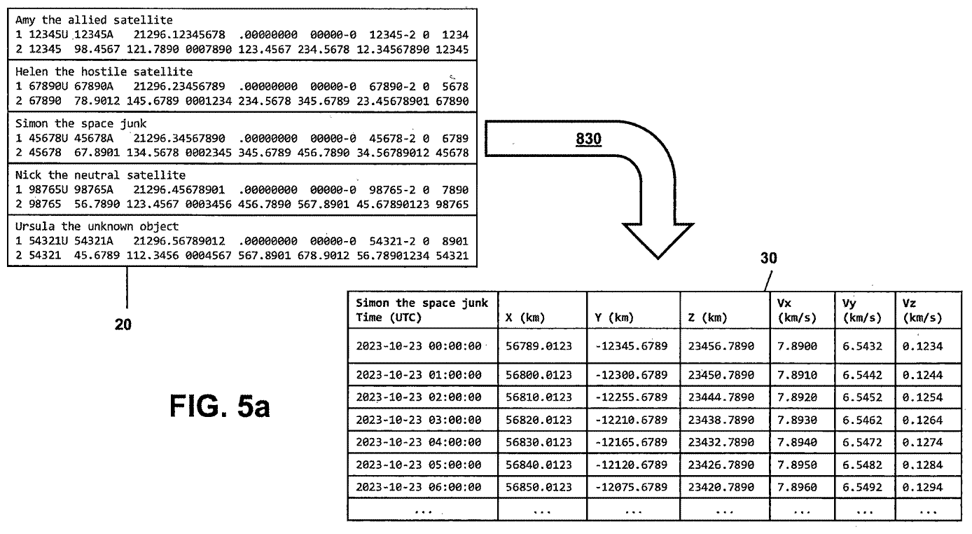

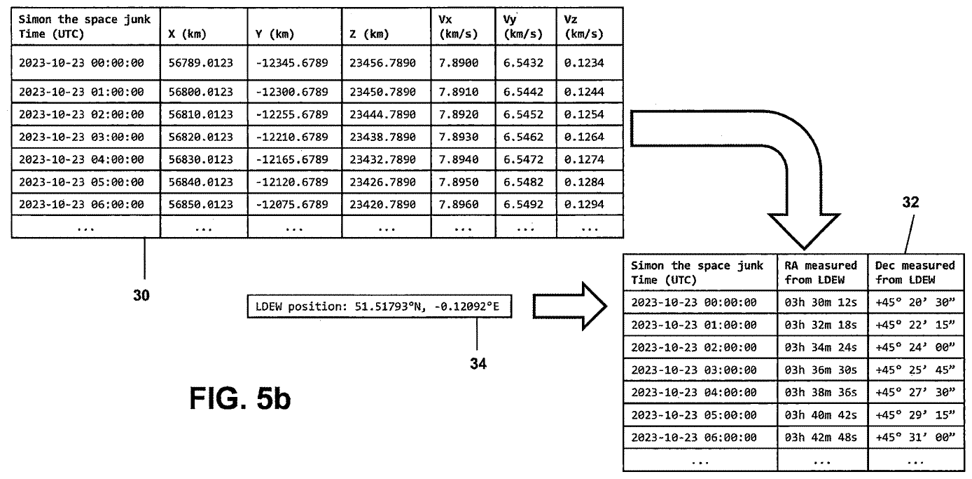

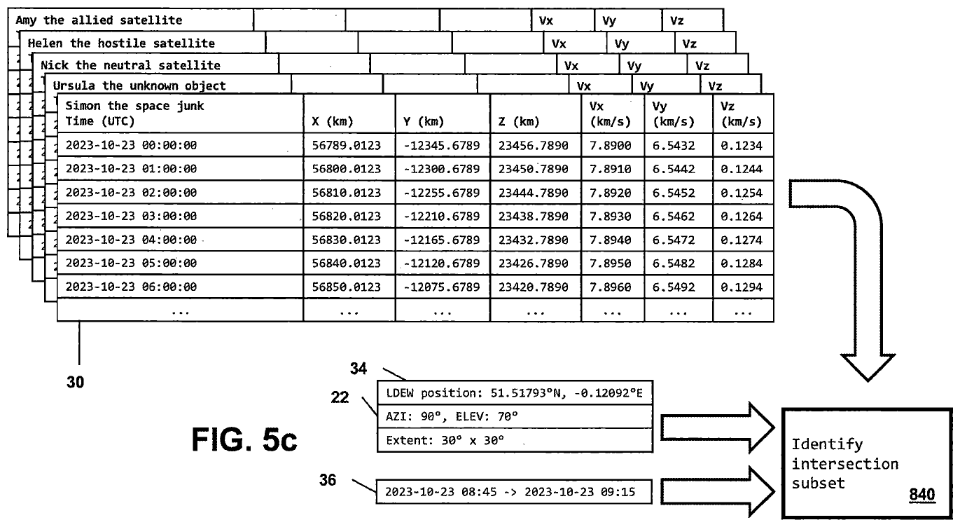

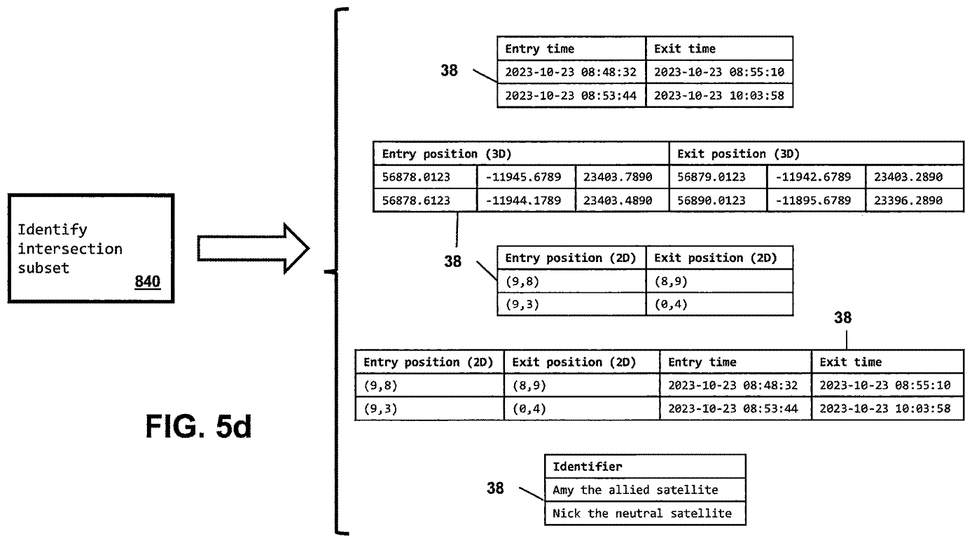

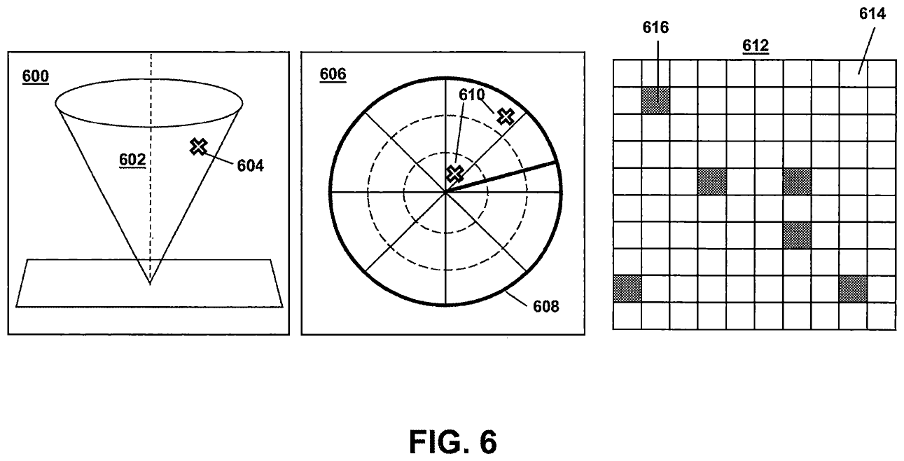

The amount of orbital trajectory forecast data calculated from the orbital element data, and/or the timeframe spanned for generating the data (e.g., in the case of data 30 described below with reference to FIG. 5a, the number of rows in the table, resolution of the timestamps and/or gaps between successive timestamps) may be selected for a given implementation of the method based on how frequently the method is expected or intended to be executed. For example, if the method is performed once every 24 hours, the orbital trajectory forecast data may comprise data identifying the predicted positions of a space object over the coming 24 hour period. If the method is to be performed more frequently, the size of the orbital trajectory forecast data can be reduced to contain just data identifying just the predicted positions of the space object until the next scheduled run of the method. Alternatively, the same amount of data may be used, but with higher-resolution timestamps (e.g., position data for each 15 minute interval instead of each hour, if the method is run every 6 hours instead of every 24).

Likewise, the amount of tracking data for the plurality of air objects may be selected for a given implementation of the method based on how frequently the method is expected or intended to be executed. For example, if the method is performed once every 24 hours, the tracking data may comprise data identifying the predicted positions of an air object over the coming 24 hour period. If the method is to be performed more frequently, the size of the tracking data can be reduced to contain just data identifying just the predicted positions of the air object until the next scheduled run of the method. Alternatively, the same amount of data may be used, but with higher-resolution timestamps (e.g., position data for each 15 minute interval instead of each hour, if the method is run every 6 hours instead of every 24).

Once the deconfliction tool has received a transmitted or stored dataset comprising data for each object that is calculated to intersect the targeted sky region during the given time range (e.g., the coming 24 hours), informed and sensible deconfliction/firing decisions can be made autonomously by the LDEW commander and/or operator for that entire range of time without needing to contact HQ again, thus providing an improvement in the form of reduced latency.

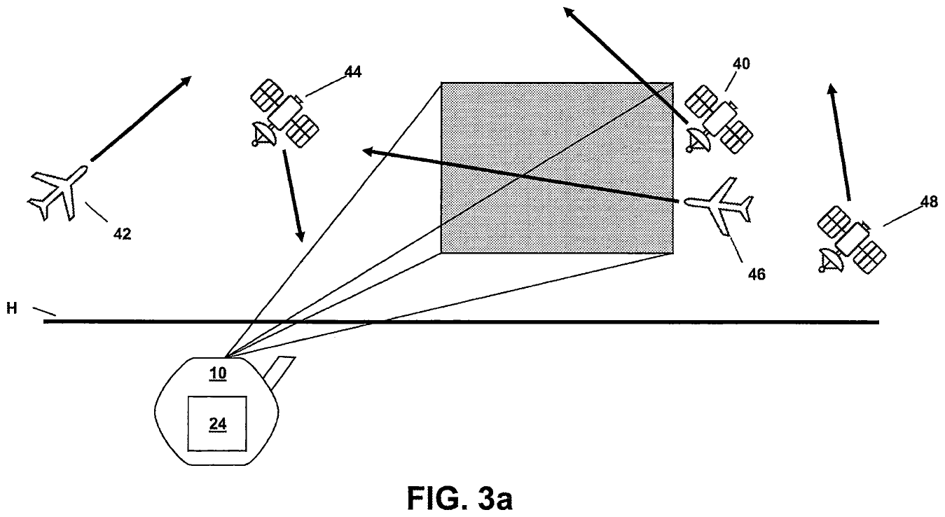

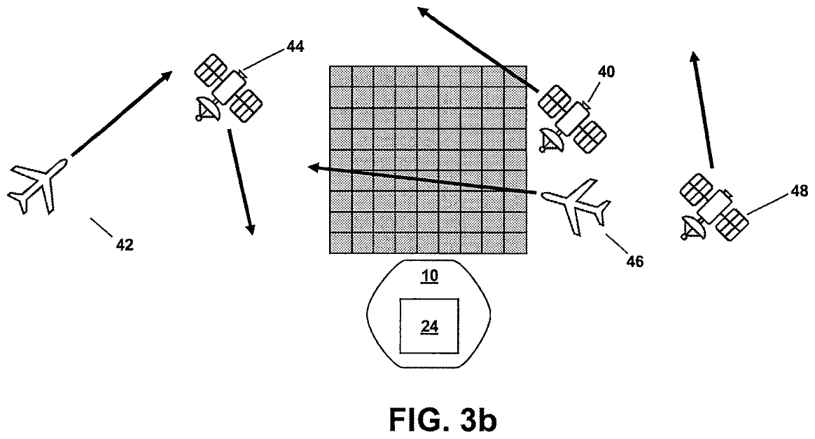

FIG. 3a graphically depicts calculated orbital trajectory forecasts for each of a plurality of air objects 42, 46 and space objects 40, 44, 48 over a given time range, and a sky region targeted by an LDEW system 10. As can be seen, LDEW system 10 targets a region of sky above the horizon H based on a point of focus in a specific direction and a chosen angular extent away from the point of focus in each direction, thus forming a window of interest. The window of interest (and hence the targeted sky region) may appear square or oblong to the observer, though defines a three-dimensional volume encompassing objects at a range of distances.

The targeted sky region may comprise a cone, field, zone, sector, patch, frustum, volume, or area of the sky. It may be defined as particular angular extent. It may comprise elevation and azimuth information. Optionally, it may also comprise a spatial extent towards the sky—that is, the targeted sky region may only extend as far as a certain distance from the observer in a particular direction, such as 100 m, 1000 m, 5000 m, 10000 m, and so on—though this is not necessary (i.e., the targeted sky region may extend infinitely far out into space). Where the targeted sky region comprises a spatial extent toward the sky, this may be defined in terms of height, e.g., height above sea level, particularly when the targeted sky region is defined by reference to the vertical (direction perpendicular to the surface of Earth).

The targeted sky region may be defined by reference to a focal point in the sky (also known as a point of view), e.g., a particular window or angular extension around the focal point.

The angular extent of the target sky region may be between one and five degrees, between five and ten degrees, between ten and twenty degrees, between twenty and forty-five degrees, between forty-five and ninety degrees, between ninety and one-hundred-and-thirty-five degrees, or between one-hundred-and-thirty-five and one-hundred-and-eighty degrees (inclusive of these endpoints).

The angular extent may be uniform (e.g., in the case where the targeted sky region resembles a cone). The angular extent may comprise an angular extent in a first direction and an angular extent in a second direction, which may be orthogonal to the first direction (e.g., in the case where the targeted sky region resembles a rectangular window). The angular extent in the first and second directions may be different extents, each of which may be in one of the ranges listed above.

FIG. 3b graphically depicts the same forecasts for the same objects 40, 42, 44, 46, 48 from the perspective of the LDEW system 10 and shows the targeted sky region subdivided into a plurality of sub-regions. In this illustrated case, the targeted sky region is subdivided into 81 equally-sized subregions, though any suitable number of subregions may be used, for example 2, 3, 4, 5, 6, 7, 8, 9, 16, 25, 36, 49, 64, or 100. In the illustrated case the targeted sky region appears as a square to the observing LDEW, as do each of the subregions. It can be seen from FIGS. 3a and 3b (most clearly from 3b) that in this example, space object 40 and air object 46 are forecasted to intersect the targeted sky region during the given time range, whereas space objects 44 and 48 and air object 42 are not.

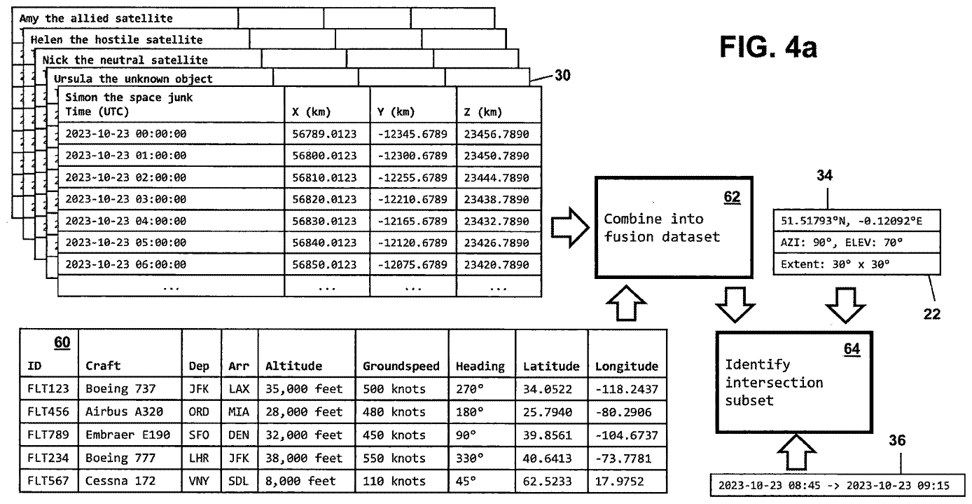

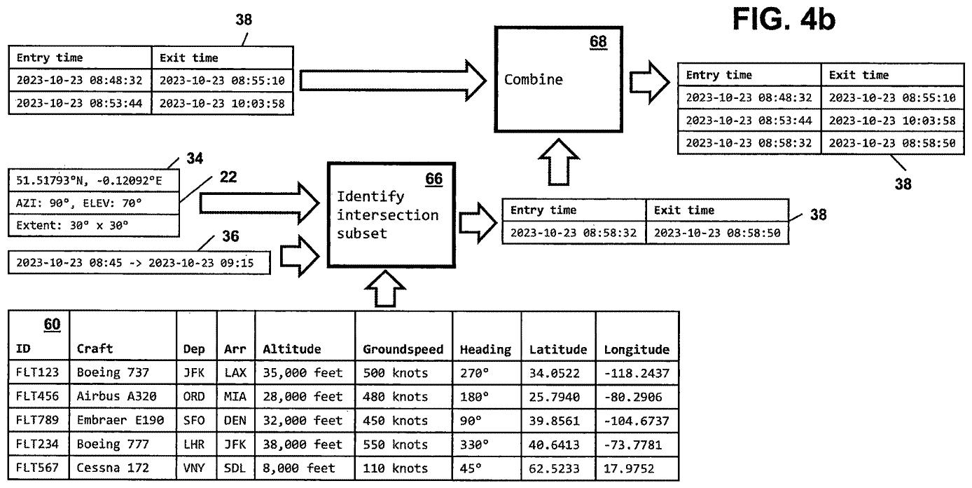

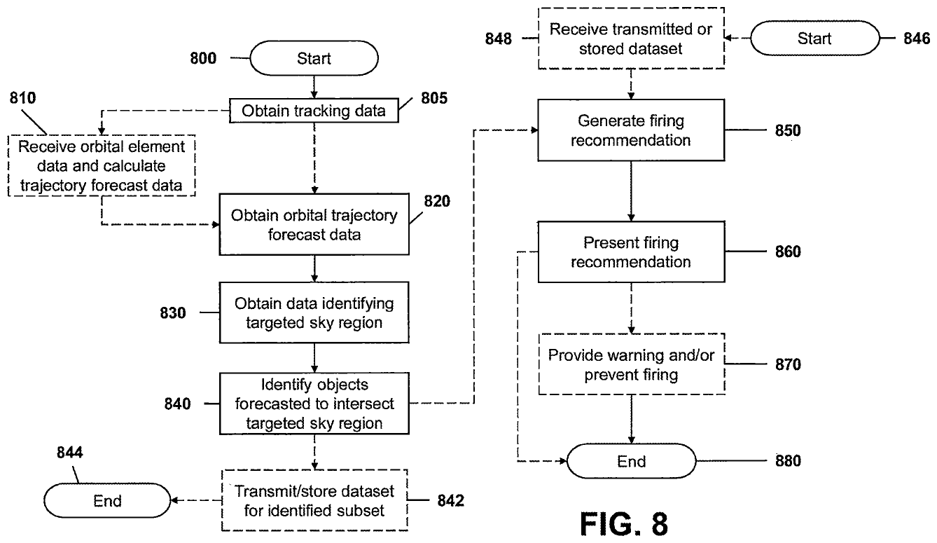

FIG. 4a illustrates a first example of air object tracking data 60 being used alongside orbital trajectory forecast data 30 to identify a subset of a plurality of objects forecasted to intersect a targeted sky region. In the illustrated example of FIG. 4a, the tracking data is combined 62 with calculated orbital trajectory forecast data 30 to obtain a fusion dataset. The fusion dataset may comprise position data, tracking data and/or forecast data for each of the plurality of objects (altogether, throughout air and space) described by air object tracking data 60 and orbital trajectory forecast data 30. In a further step 64, the data 22 identifying the targeted sky region and data 36 identifying the given time range are used to identify a subset of objects (including air objects and space objects) that are forecasted to intersect the targeted sky region during the given time range. The calculation of step 64 may be the same as, or substantially similar to, the calculation used in step 840 illustrated in FIG. 8 (in which a subset is identified of the plurality of space objects that are forecasted to intersect the targeted sky region during a given time range, based on their respective orbital trajectory forecast data).

FIG. 4b shows a second example of air object tracking data being used to identify a subset of a plurality of objects forecasted to intersect a targeted sky region. In the illustrated example of FIG. 4b the tracking data is first used to identify 66 a subset of the plurality of air objects that are forecasted to intersect the targeted sky region during the given time range, based on their respective tracking data. A first dataset 38 is output for this subset of air objects, and is subsequently combined 68 with a second dataset 38 comprising data for each space object in a subset of the plurality of space objects that are forecasted to intersect the targeted sky region during the given time range based on their respective orbital trajectory forecast data. The second dataset may have been obtained before, after, or concurrently with the first dataset. In any case, the datasets can be combined to produce a third dataset 38 comprising data for each object in a subset of the plurality of (overall) objects that are forecasted to intersect the targeted sky region during the given time range.

Because the types, formats, and structures of data used to represent, reason about, and predict the motion of air objects are often fundamentally different to the those used to represent, reason about, and predict the motion of space objects, it is currently perceived in the art to be very challenging to fuse air object data and space object data into a single coherent dataset. The differences in the nature of the data make it challenging to fuse the datasets in a general manner. To enable air/space object deconfliction with a high degree of confidence, both data types should be considered by a deconfliction tool (optionally simultaneously) so that the correct decision is made.

A key aspect of the present invention is the realization by the inventors that these datasets can be usefully fused in a computationally tractable way by limiting the scope of the problem to a predetermined targeted region of the sky—deconfliction can then be performed by working out when objects are (or should be, or may be) entering the targeted sky region. Thus, the invention provides an elegant method for integrating the two data feeds into a single visualization or message feed in order to inform the LDEW crew whether it is safe to fire or not.

For space objects, as discussed above, forecasting can be performed (for example, a couple of hours ahead of the required use of the resultant dataset in deconfliction). The forecasting can as discussed use coordinates in any suitable format such as azimuth, elevation, and/or bearing format. The same data format may optionally be used to describe the angular extent of the targeted region.

Air object tracking data (e.g., aircraft tracking data) can come from a number of sources or combinations of sources. Some possible such sources may provide air object position data in terms of latitude, longitude, and elevation. This data can be transposed into a common coordinate system or format to that used to describe the space object trajectory forecast data, to determine whether and which the air objects intersect with the targeted sky region. The present invention may comprise a step of determining whether at least one air object is predicted to enter the targeted sky region based on the tracking data of the at least one air object. In one embodiment, this prediction may comprise applying a Kalman filter to the tracking data for the at least one air object to determine whether the air object will enter the targeted sky region during the relevant time range, or at least to determine a relative probability that the air object will enter the targeted sky region during the relevant time range. In either case, the determination can optionally comprise predicting entry and exit times and/or locations relative to the targeted sky region.

In some examples, the air object tracking data may be real-time tracking data. In some examples, the air object tracking data comprises predicted location data for a window of time. In some examples, this window of time is shorter than the window of time to which the obtained/calculated orbital trajectory forecast data relates, and optionally an order of magnitude shorter than said window. In some examples, the window of time for which the location data is predicted in the air object tracking data is in the order of seconds, for example from one second to two seconds, from two seconds to three seconds, from three seconds to five seconds, from five seconds to ten seconds, from ten seconds to thirty seconds, or from thirty seconds to sixty seconds, or any sub-range or combination thereof or therebetween. The air object tracking data may comprise a timestamp for each position measurement.

In some examples, the air object tracking data may optionally further comprise velocity data, such as one or more velocity measurements. In some embodiments, the air object tracking data may comprise one or more covariance values relating to the position and/or velocity data. By “covariance value”, what is meant is a measure of the error in making the respective measurement. Including covariance values in the air object tracking data has been found by the inventors to improve the prediction accuracy of the Kalman filter. Of course, it will be understood that the air object tracking data may be obtained in any suitable known format. The air object tracking data may comprise a track data set.

If, during the relevant time window, the data for an air object (or at least a non-hostile air object) intersects (or is predicted to be about to intersect) the targeted sky region, a determination can be made by the deconfliction tool that it is unsafe to fire the LDEW into that region. Any one of a number of suitable methods for determining this intersection may be used, including but not limited to the same methods described herein for determining the intersection or predicted intersection of a given space object with the targeted sky region.

FIG. 5a illustrates an example of orbital trajectory forecast data 30 for a space object being calculated (step 810) based on orbital trajectory forecast data 20 received for a plurality of space objects. The process may be any one of the various known approaches for calculating orbital trajectory forecast data from orbital element data with which those of ordinary skill in the art will be familiar, such as any one or more of the following: simplified perturbation models (e.g., SGP, SGP4, SDP4, SGP8, or SDP8), gaussian orbit determination, Lambert's problem solver, batch least squares estimation, extended Kalman filter (EKF) methods, sequential filter methods, numerical integration methods, Cowell's method, perturbation theory, and/or Monte Carlo methods. In one exemplary embodiment, the SPG4 algorithm is used. It will be appreciated that not all of the entire functionality, output or power of any given algorithm will necessarily be required for the purposes of the present invention, in which effectively all that matters is the ability to make general decisions about whether a region of sky is clear of non-hostile targets, and not necessarily the ability to pinpoint locations, velocities and other data relevant to individual named or uniquely identified space objects. For example, whilst data 30 has been illustrated as comprising velocity data as well as position data, it will be appreciated that such velocity data is not essential for performing the present invention. Additional information about the SGP4 model can be found in Hoots, Felix R. ; Ronald L. Roehrich (31 Dec. 1988). “Models for Propagation of NORAD Element Sets” (PDF). United States Department of Defense Spacetrack Report (3), which is available online at https://celestrak.org/NORAD/documentation/spacetrk.pdf. The orbital trajectory forecast data may optionally be calculated using any one or more of: initial orbit determination methods, statistical initial orbit determination methods, or orbit determination methods, including the Gibbs method and/or the Herrick-Gibbs method.

The orbital trajectory forecast data may comprise data for a predetermined window of time. The predetermined window may start from the time of its calculation. The predetermined window may comprise or surround the specified time of the firing recommendation. The predetermined window may comprise orbital trajectory forecast data for each of a plurality of times between a start time and an end time.

The forecast data may optionally comprise high-resolution forecast data in the form of specific orbital positions. However, this is not necessary, and the forecast data can instead comprise low-resolution forecast data in the form of predicted occupation volumes, uncertainty fields, probabilistic position data, and so forth. Likewise, the tracking data may optionally comprise high-resolution tracking data in the form of specific aerial positions, but could instead comprise low-resolution tracking data in the form of predicted occupation volumes, uncertainty fields, probabilistic position data, and so forth. This has the advantage of easing the computational burden required to carry out deconfliction.

In some optional embodiments, a hostility status may be assigned to one or more air objects and/or space objects to improve deconfliction capabilities. In a simple example, the status may simply consist of a binary choice i.e., “hostile” or “not hostile”. In other examples, the status may offer further options and/or subdivisions for the status. For instance, rather than simply “not hostile”, classification schemes may be available including “allied” and “neutral”, or “allied” and “unknown”, or “neutral” and “unknown”, or “allied”, “neutral” and “unknown”. The “hostile” status itself may also be divided into further categories (e.g., based on a threat level, threat type, and so forth).

There are a variety of ways in which such a hostility status may be determined for air objects and/or space objects. For instance, received tracking data, orbital trajectory forecast data and/or orbital element data may comprise unique identifiers that can be cross-referenced against a dataset matching space objects to their hostility status, and/or may comprise launch data or ownership data that can be used to infer a hostility status. In some examples, air objects and/or space objects may be identifiable as having an “allied” hostility status by virtue of the source of their tracking data, orbital trajectory forecast data or orbital element data-as an example, much of the orbital element data found in a well-established publicly available space object catalogue is likely to pertain to “neutral” space objects, and little if any is likely to pertain to “unknown” objects. Likewise, much of the tracking data from any standard air traffic management feed is likely to pertain to neutral air objects, with little if any pertaining to unknown air objects. Allied forces will typically maintain or have access to information concerning allied air objects (e.g., drones) and/or space objects (e.g., satellites) that are not publicly listed in known air traffic management feeds or space object catalogues (or at least not listed with full orbital element data), allowing these objects to be recognized and assigned “allied” status. Information may also be maintained concerning tracked or targeted hostile air or space objects, e.g., based on a non-public source such as radar data or SDA/SSA sensor data from allied forces, and similarly used to assign a hostility status. Air or space objects which are detected (e.g., by SDA/SSA sensor data) but about which there is nevertheless no record in public catalogues, feeds, or datasets, nor in maintained lists or known allied or hostile air or space objects, can be assigned “unknown” status. The status of one or more of the air objects may be determinable from unique identifiers, nationality identifiers, sensor data, military intelligence, and/or public records.

By knowing and accounting for the hostility status of air objects or space objects, criteria for generating the firing recommendation can be adjusted intelligently. For example, as explained above, a positive firing recommendation may be generated even when an air or space object is determined to occupy the targeted sky region, based on a hostility status of the object indicating that the object pertains to hostile forces. A positive firing recommendation may be generated even when an air or space object is determined to occupy the targeted sky region, based on a hostility status of the object indicating that the object pertains to anything other than an allied force. For “neutral”, “unknown” or other similar hostility status indications, the system may simply issue information or a warning to the user/operator and leave the decision of whether to fire to their own judgement and discretion. It will be appreciated that the present invention may be carried out without ever identifying a hostility status of any of the air or space objects, since useful recommendations not to fire an LDEW can be provided simply by determining that an object is present in the targeted sky region (irrespective of status).

The use of hostility status information is advantageous because it allows more refinement and discretion in the exercise of fire/no-fire decisions without it ever being necessary to know, record or track the unique identities of any of the air or space objects individually. For instance, the information in the transmitted or stored dataset (for each object in the subset) may simply contain hostility status information for each object without the receiving deconfliction tool, LDEW or operator/user ever having to worry about identities of the objects being tracked and plotted. That is, occupancy of the targeted sky region by an object can be determined without uniquely identifying said space object.

FIG. 5b shows an example of orbital trajectory forecast data 30 in an alternative format 32, relative to a position 34 of an LDEW. Whilst the first format represents a forecast in 3-dimensional position coordinates relative to the Earth, the alternative format 32 represents the same forecast in coordinates relative to the LDEW position—in this case, in terms for right ascension and declination. The coordinate transform can be performed using any of a variety of very well-known mathematical methods with which the skilled person will be familiar (and which are not discussed herein for the sake of brevity).

FIG. 5c illustrates an example of data 22 identifying a targeted sky region alongside orbital trajectory forecast data. As can be seen, the data 22 comprises the LDEW position 34 in this case. The targeted sky region, the orbital trajectory forecast data 30, and a given time range all feed into the step 840 of identifying a subset of the plurality of space objects that are forecasted to intersect the targeted sky region during the given time range based on their respective orbital trajectory forecast data.

FIG. 5d presents various examples of formats for a dataset 38 comprising data for each object in a subset of a plurality of objects (e.g., including a plurality of air objects and/or a plurality of space objects) that are forecasted to intersect a targeted sky region during a given time range. Examples include data identifying entry and exit times for an object into and out of the region of interest; entry and exit positions (in either 3D coordinates relative to the Earth or 2D coordinates relative to the LDEW), unique identifiers of the objects, or combinations of the above. The data may in practice be in any suitable format, e.g., as comma-separated variables (CSV).

FIG. 6 presents various examples of graphical user interface features 600, 606, 612 that are suitable for presenting a firing recommendation to a user. One exemplary feature 600 includes a velocity azimuth display visualization comprising a cone 602 representing the targeted region. The cone may be color-coded based on the firing recommendation. The cone may comprise one or more representations 604 of positions and/or trajectories for one or more air objects and/or space objects. One exemplary feature 606 comprises a 2D plan view 608 comprising representations 610 of positions and/or trajectories for one or more air objects and/or space objects.

One exemplary GUI feature 612 comprises representations 614 of each of a plurality of sub-regions of the targeted sky region. The user can be shown whether or not it is safe to fire into any given sub-region at the time that they are using the deconfliction tool by modifying one or more visual properties of the corresponding representation 614 on the GUI. For instance, when it is unsafe to fire an LDEW into a sub-region of the sky, the representation for that sub-region may be colored red (or black, or grey, etc.), and/or may flash, and/or may be marked with an icon.

Of course, all such GUI features are optional and non-essential, with simpler means of displaying a firing recommendation including e.g., turning a light/LED on when the LDEW can be safely fired at the targeted sky region and off when it cannot; turning a light/LED off when the LDEW can be safely fired at the targeted sky region and on when it cannot; changing a color of a light/LED when the LDEW can/cannot be safely fired at the targeted sky region; and so forth.

If a GUI is used to present the firing recommendation, the GUI may comprise one or more (e.g., a combination) of the above and other GUI features. The GUI may be customizable for different LDEW platforms and user preferences and may provide a common visualization of air and space objects of concern. In some examples, the invention may comprise user preference settings that allow the methods, presentations, calculations, and/or data formats to be personalized according to the preferences of individual users. These user preference settings may include, for example, the ability to adjust the level of detail presented in the GUI, the ability to customize the color-coding scheme used to represent the firing recommendation, and the ability to set preferences for how the firing recommendation is calculated and presented. By allowing users to personalize the method according to their preferences, the invention can enhance usability of the deconfliction tool and improve the overall user experience.

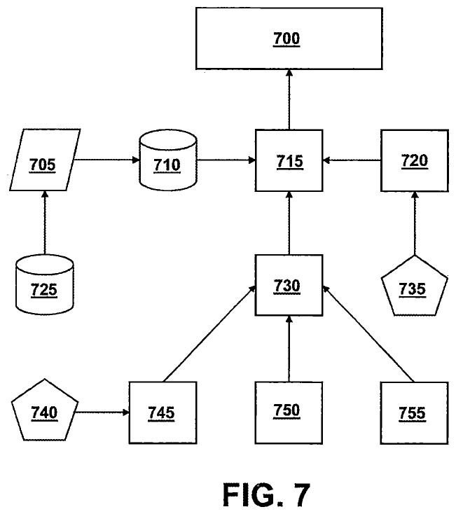

FIG. 7 is a component diagram of one exemplary embodiment of the present invention, showing the various components and their interactions, including: space object orbital element data 725; a trajectory prediction/forecasting process 705; occupancy prediction data 710 for the target sky region; a sensor 735 of an LDEW system, suitable for local area surveillance; a beam management system 720 of the LDEW system; a wide area sensor feed 740; air object sensor track data 745; air traffic management data 750; allied force track data 755; a local air picture 730; a fusion engine 715; and a graphical user interface 700 for an airspace deconfliction tool.

FIG. 8 is a flow diagram depicting steps of various aspects of the present invention. In one aspect, a method begins at 800 and includes obtaining 805 tracking data for each of a plurality of air objects; obtaining 820 orbital trajectory forecast data for each of a plurality of space objects; obtaining 830 data identifying a targeted sky region; identifying a subset of objects that are forecasted to intersect the targeted sky region during a given time range from the pluralities of air objects and space objects, based on their respective tracking data or orbital trajectory forecast data; generating 850 a firing recommendation for the targeted sky region for a specified time, based on the received dataset; and presenting 860 the firing recommendation to a user via a display device. In a further (completely optional) step 870, the method can also comprise, in accordance with the firing recommendation being a negative firing recommendation, providing a warning to an operator of a weapon system (optionally wherein the warning is provided in response to a firing input made by said operator to the weapon system) and/or preventing a weapon system from being fired. In another separate completely (and independently) optional step, the orbital trajectory forecast data may be obtained by receiving orbital element data for a plurality of space objects and calculating, based on the received orbital element data, the orbital trajectory forecast data for each space object. In any case, the method ends at 880.

As will be appreciated, whilst the entirety of the method may be carried out on a single device in a single location, embodiments of the present invention are contemplated in which the method begins at 800, steps 805-840 (optionally including step 810) are performed, a step 842 is performed in which a dataset comprising data for each object in the subset is transmitted or stored, and then the method ends at 844. Embodiments are also contemplated in which the method begins 846 with the receipt 848 of such a transmitted/stored dataset, after which steps 850-860/870 are performed and the method ends at 880. Advantageously, in this way, the first subset of the method steps may be carried out on or by a first device, and the second subset can be carried out on or by a second device. Additionally or alternatively, the first subset can be carried out in a first location (such as HQ) and the second subset can be carried out in a second location (such as a combat zone).

The step of generating the firing recommendation and/or the step of presenting the firing recommendation to the user may be performed at the “specified time”. That is, the firing recommendation may be generated based on whether one or more of the air objects or space objects are predicted to be “currently” or “presently” occupying the targeted sky region at the time of generating and/or presenting the recommendation.

As used in the above, the “user” may be any person viewing the displayed firing recommendation, including but not limited to a person operating an LDEW system. As used in the above, the “operator” may be any person operating an LDEW system, including but not limited to a person viewing the displayed firing recommendation. That is, the user and operator may be the same person or two distinct people.

Based on the generated firing recommendation, in optional step 870 firing can be prevented, restricted or caveated with a warning in order to enhance safety and reduce the risk of fratricide or other unintentional collateral damage. This optional feature further enhances the safety of the LDEW operation by providing an additional layer of protection against unintentional collateral damage.

In one example, when a negative recommendation is generated, a generic warning may be provided even without any input being made to the LDEW by its operator. In one example, the warning is provided in response to an operator's firing input, such as in response to an attempt to aim the weapon, prime the weapon, or fire the weapon. For instance, a warning can be provided to a user or operator when the operator aims at a target in the targeted sky region (and optionally in a sub-region thereof) when it has been determined that an air or space object (or at least a non-hostile air or space object) currently occupies the region (or sub-region as the case may be) and attempts to engage firing means of the LDEW, such as a firing trigger.

In one example, the LDEW can be locked or blocked from firing when the region (or a targeted sub-region) is occupied. In some examples an option to override the prevention of firing may be provided to the operator of the LDEW system to guarantee improved flexibility. In other examples, no override is provided, in order to guarantee improved safety controls. In any case, step 870 of providing the warning and/or preventing/restricting firing of the LDEW may be, but need not be, based solely on the identification of an air or space object in the targeted sky region. Other data sources may be integrated into and may inform the process of providing the warning and/or preventing/restricting firing of the LDEW based on the identification of any other unsafe conditions or risks to air or space objects or to the LDEW crew.

The term “comprising” encompasses “including” as well as “consisting” e.g. a composition “comprising” X may consist exclusively of X or may include something additional e.g. X+Y.

Unless otherwise indicated each embodiment as described herein may be combined with another embodiment as described herein.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, hard-drives, thumb drives, memory cards, etc. and do not include propagated signals. The software can be suitable for execution on a parallel processor or a serial processor such that the method steps may be carried out in any suitable order, or simultaneously. This acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP (Digital Signal Processor), programmable logic array, or the like.

It will be understood that the benefits and advantages described above may relate to one embodiment or may relate to several embodiments. The embodiments are not limited to those that solve any or all of the stated problems or those that have any or all of the stated benefits and advantages.

The steps of the methods described herein may be carried out in any suitable order, or simultaneously where appropriate. Additionally, individual steps may be deleted from any of the methods without departing from the scope of the subject matter described herein. Aspects of any of the examples described above may be combined with aspects of any of the other examples described to form further examples without losing the effect sought. Any of the steps or processes described above may be implemented in hardware or software.

It will be understood that the above descriptions of preferred embodiments are given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the scope of this invention (which is defined by the appended claims).

What is claimed is:

1. A computer-implemented method comprising:
obtaining:
tracking data for each of a plurality of air objects;
orbital trajectory forecast data for each of a plurality of space objects; and
data identifying a targeted sky region;
identifying a subset of objects that are forecasted to intersect the targeted sky region during a given time range from the pluralities of air objects and space objects based on their respective tracking data or orbital trajectory forecast data; and
transmitting or storing a dataset comprising data for each object in the subset.

2. The method of claim 1, wherein obtaining the orbital trajectory forecast data comprises:
receiving orbital element data for the plurality of space objects; and
calculating, based on the received orbital element data, the orbital trajectory forecast data for each space object.

3. The method of claim 2, wherein the orbital element data comprises a plurality of two-line element sets.

4. The method of claim 2, wherein the orbital element data is derived from at least one of:
one or more space object catalogues;
one or more space domain awareness sources;
one or more space situational awareness sources;
one or more space surveillance/tracking sources; or
one or more ground-based or space-based cameras or sensors.

5. The method of claim 1, wherein the tracking data comprises at least one of:
local air picture data;
air traffic management data;
allied force air object tracking data;
wide-area sensor feed (“WASF”) data; or targeting data from a sensor of a laser directed energy weapon (LDEW) system.

6. The method of claim 1, wherein a laser directed energy weapon system obtains the transmitted or stored dataset.

7. The method of claim 6, wherein the laser directed energy weapon is configured, in accordance with the firing recommendation being a negative firing recommendation, to:
provide a warning to an operator of the weapon system; and/or
prevent the weapon system from being fired.

8. A computer-implemented method comprising:
receiving a transmitted or stored dataset comprising data for each object from a plurality of air objects and a plurality of space objects that is calculated to intersect a targeted sky region during a given time range;
generating a firing recommendation for the targeted sky region for a specified time based on the received dataset; and
presenting the firing recommendation to a user via a display device.

9. The method of claim 8, wherein the firing recommendation is generated by determining whether any space object is forecasted to occupy the targeted sky region at the specified time.

10. The method of claim 8, wherein presenting the firing recommendation to the user comprises presenting at least one of:
a graphical user interface;
a velocity azimuth display visualization;
a 2D plan view;
a cone representing the targeted region;
representations of positions and/or trajectories for one or more air objects; or
representations of positions and/or trajectories for one or more space objects.

11. The method of claim 8, wherein:
the received dataset comprises positional data and timing data for each air or space object calculated to intersect the targeted sky region during the given time range; and
presenting the firing recommendation to the user comprises:
computing a firing recommendation for each of a plurality of sub-regions of the targeted sky region; and
presenting a graphical user interface depicting the firing recommendation computed for each sub-region.

12. The method of claim 8, wherein the transmitted or stored dataset comprises, for each space object in a subset of the plurality of space objects and for each air object in a subset of the plurality of air objects, entry and/or exit timing data for each of a plurality of sub-regions of the targeted sky region.

13. The method of claim 11, wherein:
the targeted sky region has an angular extent of 30 degrees by 30 degrees; and
the plurality of sub-regions comprises nine sub-regions each with an angular extent of 10 degrees by 10 degrees.

14. The method of claim 8, wherein a laser directed energy weapon system receives the transmitted or stored dataset, generates the firing recommendation, and presents the firing recommendation.

15. The method of claim 14, wherein the laser directed energy weapon is configured, in accordance with the firing recommendation being a negative firing recommendation, to:
provide a warning to an operator of the weapon system; and/or
prevent the weapon system from being fired.

16. The method of claim 8, further comprising, in accordance with the firing recommendation being a negative firing recommendation:
providing a warning to an operator of a weapon system; and/or
preventing a weapon system from being fired.

17. A computer-implemented method comprising:
obtaining:
tracking data for each of a plurality of air objects;
orbital trajectory forecast data for a plurality of space objects; and
data identifying a targeted sky region;
identifying a subset of objects that are forecasted to intersect the targeted sky region during a given time range from the pluralities of air objects and space objects, based on their respective tracking data or orbital trajectory forecast data;
generating a firing recommendation for the targeted sky region for a specified time, based on the identified subset; and
presenting the firing recommendation to a user via a display device.

18. The method of claim 17, wherein presenting the firing recommendation to the user comprises presenting at least one of:
a graphical user interface;
a velocity azimuth display visualization;
a 2D plan view;
a cone representing the targeted region;
representations of positions and/or trajectories for one or more air objects; or
representations of positions and/or trajectories for one or more space objects.

19. The method of claim 17, wherein a laser directed energy weapon system generates the firing recommendation and presents the firing recommendation.

20. The method of claim 17, further comprising, in accordance with the firing recommendation being a negative firing recommendation:
providing a warning to an operator of a weapon system; and/or preventing a weapon system from being fired.
